(19) United States
(12) Patent Application Publication
(10) Pub. No.: US 2013/0169081 A1
(43) Pub. Date: Jul. 4, 2013

(54) SEGMENT ROTOR FOR AN ELECTRICAL MACHINE

(71) Applicants: Reiner Grillenberger, Windsbach (DE); Gerhard Gömmel, Postbauer-Heng (DE); Thomas Koch, Nurnberg (DE); Olaf Sprockhoff, Allersberg (DE); Klaus Streng, Nurnberg (DE)

(72) Inventors: Reiner Grillenberger, Windsbach (DE); Gerhard Gömmel, Postbauer-Heng (DE); Thomas Koch, Nurnberg (DE); Olaf Sprockhoff, Allersberg (DE); Klaus Streng, Nurnberg (DE)

(73) Assignee: Siemens Aktiengesellschaft, Munchen (DE)

(21) Appl. No.: 13/823,835

(22) PCT Filed: Sep. 19, 2011
(86) PCT No.: PCT/EP11/66173

§ 371 Date: Mar. 15, 2013

(30) Foreign Application Priority Data
Sep. 24, 2010 (EP) 1017927.1

(51) Int. Cl. H02K 1/32; H02K 9/04; H02K 1/27

(52) U.S. Cl. CPC H02K 1/32; H02K 1/27; H02K 9/04
USPC 310/59

(57) ABSTRACT

A rotor for an electrical machine has a plurality of segments. The segments have permanent magnets. A fan can be arranged at least between two segments. The plurality of segments jointly form a rotor core having axial ends, with end sheets respectively attached to the axial ends of the rotor core.

The invention relates to an electrical machine comprising a rotor and a stator.

An object of the present invention is to embody a rotor of an electrical machine such that this can be designed in a simple and flexible manner, wherein effective cooling is in particular to be taken into account here.

The object is achieved with a subject matter as claimed in one of claims 1 to 7.

From a specific output of an electrical machine, it may result that axial ventilation of the rotor via cooling slots in permanently excited electrical machines is in itself no longer sufficient to discharge the developing thermal losses. An additional cooling effect can be achieved by means of a radial ventilation. If a PEM rotor, in other words a rotor of a permanently excited synchronous machine, with internal, in particular countersunk magnets, is split into sub packets with radial ventilation, the discharge of thermal energy can thus be increased. The sub packets in this way form segments of the rotor of the electrical machine. When the rotor is split into two or more segments, assembly and/or fixing of the permanent magnets segment by segment is now also possible. A casting of the permanent magnets of the rotor can also take place segment by segment. This means that a plurality of segments of a rotor is firstly cast in order to combine the segments thereafter to form a rotor. As a result, different lengths of the rotor can also be produced as a function of the number of segments used. Here the permanent magnets can be fixed in a specific segment without a direct fixing to further segments occurring. The permanent magnets can be indirectly fixed in terms of their position also to other segments by the segments themselves being fixed to one another. This can take place for instance by means of press fitting on a shaft, by means of an adhesive, by means of screw, rivet or clamping connections etc.

In one embodiment, a single radial ventilation in the center of the rotor enables the rotor and/or the electrical machine to be ventilated. The rotor can be implemented here such that it comprises two segments with magnets. One segment on a drive side and one segment on an operating side of the electrical machine. The respective segments comprise electrical sheets and form sub packets of the rotor.

In a further embodiment, the rotor has not just two but instead three or more segments, wherein ventilation is provided between the segments. Therefore it is possible not just to realize ventilation in the center of the rotor for instance but instead a plurality of ventilations. A ventilation comprises for instance a fan wheel and/or air blades in order to produce a cooling air flow.

A rotor of an electrical machine may therefore comprise a plurality of segments, wherein the segments comprise permanent magnets. A ventilation can then be provided between the segments. The ventilation can take place between two segments by means of a fan.

The fan has a segmented rotor stacked core by virtue of the segmentation into the segments. The rotor stacked core is broken down in a modular manner into several partial stacked cores. Different segments comprise partial stacked cores. The segments and also the sub partial stacked cores can be manufactured separately and assembled with permanent magnets and/or magnetic material. This shows that magnetization also then only occurs for instance when the magnetic material is already present on the segment. The segments, in other words the magnetic material of the segments, can be magnetized individually or in groups.

In one embodiment of the rotor, a segment comprises an end plate. The end plate can fulfill the function of a pressure plate.

In one embodiment of the rotor, a segment comprises an end sheet. The end sheet closes the grooves for the permanent magnets and preferably seals the same. The end sheet and the end plate can also be embodied in one piece in one embodiment, one part then assumes the following two functions.

In an embodiment of the rotor, segments comprise a plurality of electrical sheets. A first segment therefore comprises a first packet of electrical sheets. A second segment comprises a second packet of electrical sheets etc.

A segmented sheet packet can thus be embodied for the rotor of the electrical machine.

In one embodiment of the rotor, a segment comprises a web plate.

The web plate is preferably embodied such that it fulfills the function of a pressure plate.

In one embodiment of the rotor, a fastening element holds a segment together. A plurality of fastening elements can be provided herefor.

In one embodiment of the rotor, permanent magnets are fixed on a segment such that a casting compound only connects the permanent magnets with one of the plurality of segments. The casting of permanent magnets therefore takes place segment by segment. The segments need not exhibit casting between one another.

Sub packets of a rotor may therefore comprise at least one of the following features in each instance:
an end plate which fulfils the function of a pressure plate;
an end sheet which closes and seals the grooves for the magnets;
the actual sub stacked core which contains the electric sheet,
a web plate which fulfils the function of a pressure plate and the webs of which function as fans and spacers between the sub sheets;
fastening elements (screws, rivets, clamps . . . ), which hold the sub stacked core together;
magnets (magnetized or non-magnetized) which are introduced into the sub packet, and/or
a fixing or impregnation of the magnets (adhesive, casting compound, clamps).

The individual sub packets may all be embodied with the same length so that the rotor packet can be lengthened or shortened in a modular manner. It is likewise possible to use deliberately shorter packets at thermally critical points in the rotor in order to further increase the cooling effect again here.

The sub packets can be mounted cold or warm on the shaft individually and held together on the shaft of the rotor and/or the electrical machine with tie rods (screws, bolts, rivets etc.). The shaft can be embodied from non-magnetic steel in order to simplify the assembly. The torque is transferred to the shaft by means of press-fit or a feather key for instance.

The segmentation also enables a rotor assembled with magnets to be split into any number of sub stacked cores, between which a ventilation is produced by the radially-arranged webs. The heat discharge in the rotor can herewith be increased. The modular design shows many advantages.

Possible embodiments of the invention are described in more detail below with the aid of the appended exemplary embodiments in the drawings, in which

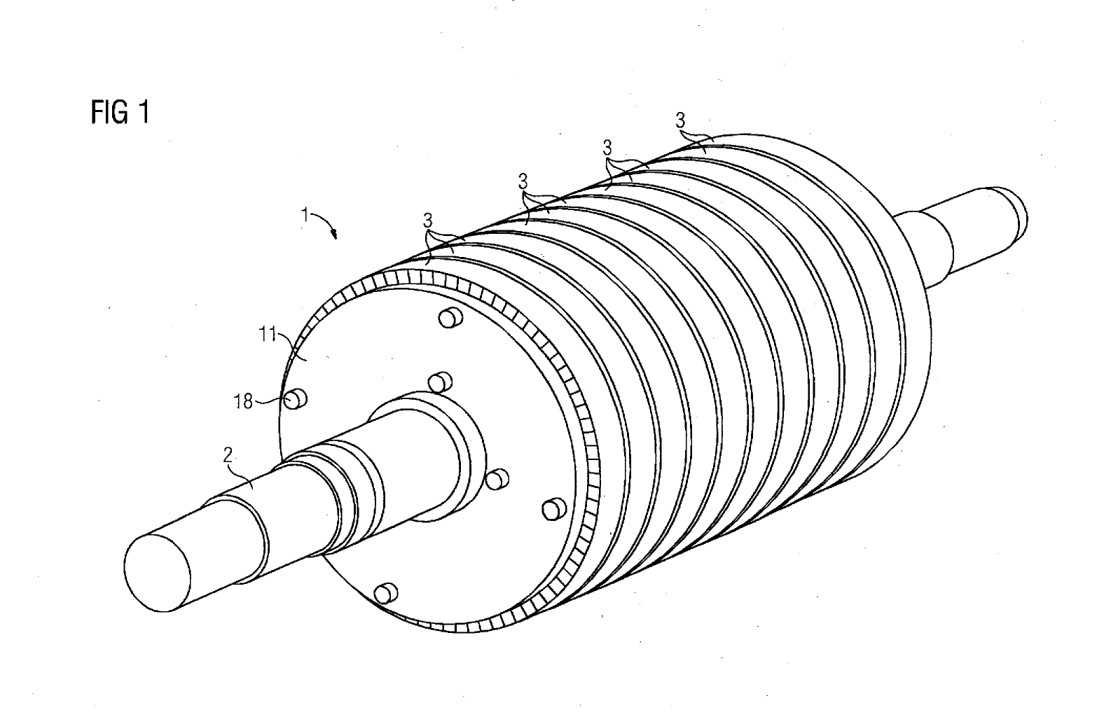

FIG. 1 shows a rotor of an electrical machine;

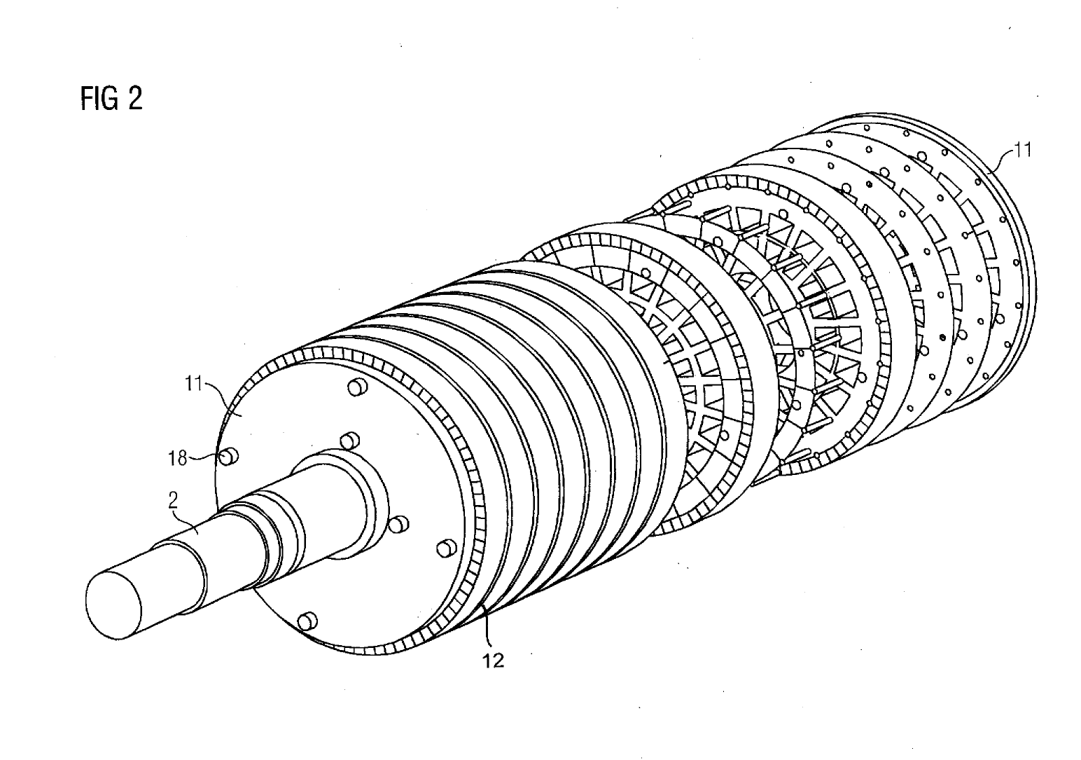

FIG. 2 shows the rotor of the electrical machine in an exploded representation;

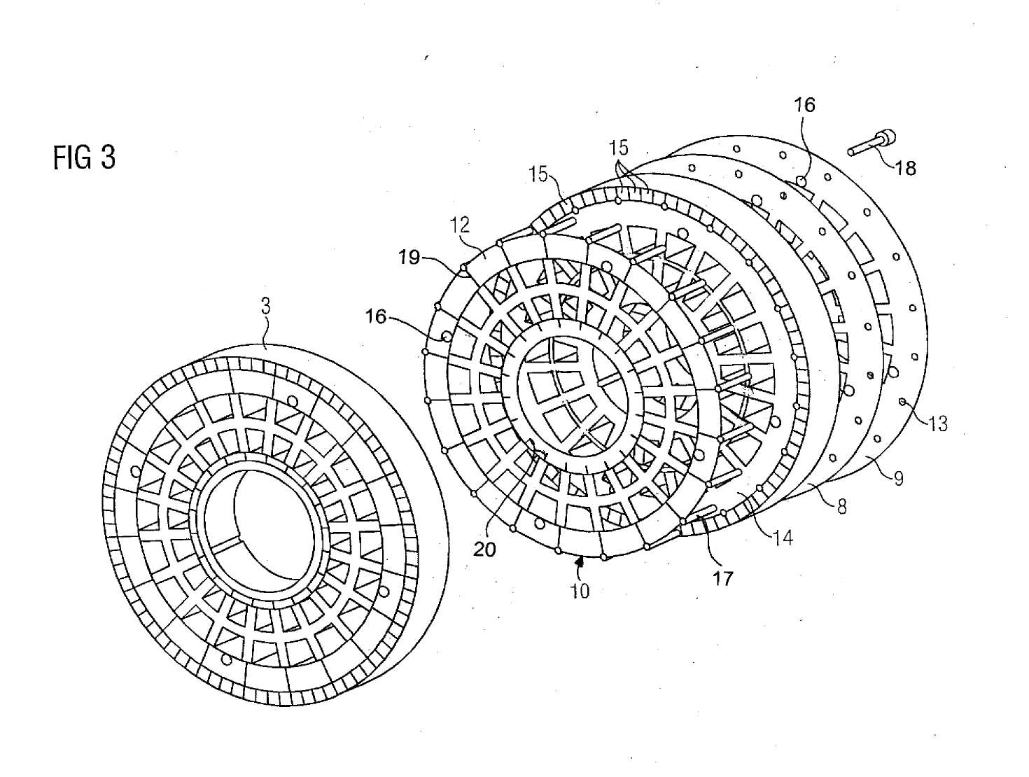

FIG. 3 shows a segment of the rotor of the electrical machine.

The representation according to FIG. 1 shows a rotor 1 comprising a plurality of segments 3 on a shaft 2. End plates 11 close the stack of segments, wherein fastening elements 18 hold the structure. The representation according to FIG. 2 shows the structure of the rotor 1 in an exploded representation.

The representation according to FIG. 3 shows a segment, as well as its exploded representation. The segment comprises a plate-type structure. End plates 9 and 10 close the segment structure. The end plate 10 has a fan 12. Cast permanent magnets 15 are disposed on a carrier plate 14. Electrical sheets 8 are provided for guiding the magnetic flow. Holes 13 are provided to allow the fastening means 17, which hold the segment 3 together, to pass through.

1.-7. (canceled)

8. A rotor of an electrical machine, comprising:
a plurality of segments;
permanent magnets provided on each of the segment; and
a radial fan arranged on an end face of a one of the segments for removing heat.

9. The rotor of claim 8, wherein the fan is arranged between the one of the segments and an adjacent one of the segments.

10. The rotor of claim 8, wherein each of the segments comprises an end plate.

11. The rotor of claim 8, wherein the plurality of segments jointly form a rotor core having axial ends, and further comprising end sheets respectively attached to the axial ends of the rotor core.

12. The rotor of claim 8, wherein each of the segments comprise a plurality of electrical sheets for guiding a magnetic flow.

13. The rotor of claim 10, wherein the end plate is configured as a web plate.

14. The rotor of claim 8, further comprising fastening elements extending through aligned holes of each of the segments to maintain integrity of each of the segments.

15. The rotor of claim 8, wherein the permanent magnets are fixed on each of the segments such that a casting compound connects the permanent magnet only with one of the plurality of segments.

16. The rotor of claim 9, wherein each of the segments comprises a carrier plate arranged adjacent to the end plate, said permanent magnets being arranged about an outer circumference of the carrier plate.
